(19) United States
(12) Patent Application Publication
(10) Pub. No.: US 2006/0053840 A1
(43) Pub. Date: Mar. 16, 2006

(54) Device for preparing textiles

(76) Inventor: Kurt Van Wersch, Wegberg (DE)

Correspondence Address: WILLIAM COLLARD;COLLARD & ROE, P.C., 1077 NORTHERN BOULEVARD, ROSLYN, NY, 11576, US

(21) Appl. No.: 10/520,344

(22) PCT Filed: Jul. 18, 2003
(86) PCT No.: PCT/DE03/02416

§ 371 Date: Jan. 5, 2005

(30) Foreign Application Priority Data
Jul. 31, 2002 (DE) 102 34 799.9

(51) Int. Cl. B08B 3/12

(52) U.S. Cl. 68/5 C

(57) ABSTRACT

The invention relates to a device for preparing textiles involving the drying and skewing of a textile web. To obviate the need for a separate skewing device, at least one group of control rolls of a hotflue that is used for drying, is mounted obliquely in relation to the central transport direction of the material web.

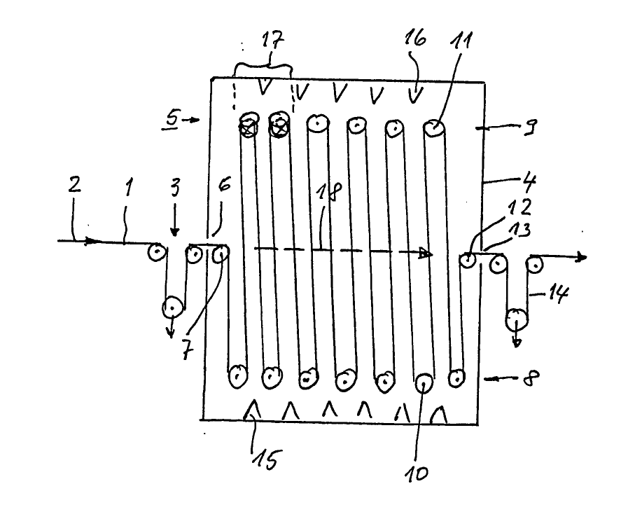

The invention relates to a device for preparing textiles that precedes their garment-making, having means, among other things, for skewing the textile web, particularly one consisting of denim goods, and having at least one hot flue and a series of guide rollers mounted essentially in one horizontal plane each, for the textile web, as well as having means that precede and follow (the hot flue), for exerting a lengthwise draw on the textile web.

The denim process chain, i.e. the production line in the manufacturing of denim clothing, e.g. so-called jeans, comprises essentially three steps, starting from the textile: denim finishing, garment-making, and finishing of the ready-made articles. Denim finishing, including preparing textiles, includes drying, stretching, and so-called skewing of the textile, frequently also with anti-shrink finishing of the textile web. In garment making, the articles of clothing are cut and sewn. The finished articles of clothing are subsequently de-sized, stonewashed, and/or bleached in the preparation of ready-made articles, piece by piece.

In skewing, the textile, particularly in the case of a twill weave, is drawn diagonally with reference to warp and weft (skew). For this purpose, skewing devices have been in use for a long time.

A device for straightening weft chains in textiles is indicated in DE 37 15 086 A1. In this weft straightener, a continuously passing textile web is stretched between two edge-side tenter drums, essentially in the weft direction, over a defined length segment, with a force that increases in the running direction; these drums can be moved, independently of one another, in such a manner that different forces in the running direction that occur in the case of skew can be balanced out.

Skews can occur when drying textile fabric webs in so-called multi-level tenter machines. Such a tenter machine is described in DE 198 01 537 A1. In this, the textile web runs through several treatment levels, and is transported over at least one deflection point, by means of two endlessly rotating transport organs, at the transition from level to level. In order to be able to straighten skews that occur in this multi-level tenter machine, at least one deflection wheel can be adjusted, relative to the other, in the longitudinal direction of the tenter machine, at a deflection point.

A hot flue is described in DE 33 36 328 C2. It comprises an upper series and a lower series of guide rollers. The two series of guide rollers are mounted in a hot flue housing, parallel to one another and horizontal—essentially in one plane each. The housing possesses a horizontal slit in an inlet wall, through which the textile web to be treated is to be introduced, spread out; correspondingly, there is an outlet slit in an outlet wall. The textile web is transported over a lower and an upper guide roller alternately, in loop shape or meander shape. Within the housing, rows of blowing nozzles arranged parallel to the guide rollers are provided, by means of which treatment media, particularly heated air—generally circulating air—are blown onto the textile web, i.e. into the stretched loops of textile web. In general, the textile web is held under a certain longitudinal tension of the textile web within the hot flue, using goods tenter means that precede and follow the hot flue. This longitudinal tension is supposed to be at least great enough so that even in the case of a goods content of thirty meters of textile web and more, an essentially fold-free goods progression within the hot flue and through it is guaranteed. The “average transport direction” in a hot flue is generally understood to be the straight, essentially horizontal connection line between the goods inlet and the goods outlet.

The invention is based on the task of obtaining the desired skew, in each instance, without special skewing devices.

The solution according to the invention consists, for the device indicated initially, having skewing means and having a hot flue with series of guide rollers mounted in it, preferably for use in denim finishing, in that at least one group of at least one series of guide rollers is mounted tilted at a slant in one direction, in relation to the horizontal plane that passes through the series of guide rollers. Tilted at a slant “in one direction” means that all of the rollers of the roller group, in each instance, are tilted in the same direction, preferably to the same extent. The guide rollers tilted, i.e. slanted according to the invention do not have to form a closed sequence; guide rollers that are mounted tilted and conventionally (horizontally) can alternate in any desired sequence.

In the case of known hot flues, the guide rollers of the upper and lower series of rollers of a hot flue were aligned as precisely parallel as possible, roller by roller, because it was generally believed that otherwise it was not possible to have a fold-free progression of the textile web through the device. In contrast to this, the invention, namely the slanting of at least one group of guide rollers, surprisingly achieves the result that the hot flue simultaneously acts as a skewing means, while fulfilling its other tasks.

Within the scope of the invention, the hot flue, which regularly has heated circulating air applied to it, can have both dry and damp goods presented to it. If a dry textile web runs into the hot flue that is equipped with slanted guide rollers according to the invention, it is skewed (at the heated air temperature). If the textile web is damp when it runs into the hot flue, it is not only skewed there, but also dried, by means of the circulating air that is blown onto it. This latter case is particularly advantageous, because then, the hot flue produces two work results that can only be obtained with two different devices, according to the state of the art, in a single work step.

A hot flue of the usual size can possess twenty guide rollers, depending on the order of magnitude, in its upper and lower series of rollers. It is sufficient for skewing if, according to the invention, part of the guide rollers of an upper and/or a lower series is aligned at a slant in relation to the transport direction of the textile web. For example, it is sufficient if about five to fifty percent of the one series of rollers, in each instance, is slanted. The degree of slant depends on the extent of the skew of the textile web to be achieved by means of slanting the rollers. Usually, desired skews are already achieved if the guide rollers in question are tilted by five to ten degrees, relative to the other guide rollers of a series (about an axis that lies parallel to the average transport direction of the textile web), in the direction towards the other series of rollers.

In the attached drawing, an exemplary embodiment of a device according to the invention is shown in principle. A vertical cross-section is shown, parallel to the average transport direction of the textile web, through a device having only a few guide rollers.

The textile web 1 runs in the transport direction 2, through a first tenter means 3, into the housing 4 of a hot flue indicated as a whole as 5. The housing 4 possesses an essentially horizontal inlet slit 6 with a deflection roller 7 as well as two series 8 and 9 of guide rollers 10 and 11, respectively, in the interior. The textile web 1 is guided around the guide rollers 10 and 11 in meander shape, up and down, and finally passed to a second tenter means 14 through an outlet slit 13 of the housing 4, by way of a deflection roller 12. Within the housing 4, blowing nozzles 15 and 16, respectively, are provided, directed into the loops of the textile web that are stretched between two guide rollers of a series 8 or 9 of rollers, in each instance.

In the case of conventional hot flues, the two series 8 and 9 of rollers and the related rollers 10 and 11, respectively, lie parallel to one another in horizontal planes. According to the invention, at least one group 17 of guide rollers of a series 8, 9 is intentionally set at a slant in relation to the other guide rollers 11 of the series, deviating from parallelity. For the purpose of slanting, the guide rollers 11 of the group 17 that are in question are tilted about an axis 18 that lies parallel to the horizontal plane of the other guide rollers of a series and/or parallel to the average textile web transport direction 2, in the direction towards the other series 9 of rollers.

The extent of the slant and the number of slanted rollers (the group 17 of the slanted rollers can comprise all the rollers of a series or even of both series 8, 9) depends on the material being treated, in each instance, and on the desired skew, in each instance. The core of the invention is therefore primarily the recognition that a separate skewing device can be entirely eliminated by setting at least part of the guide rollers of a hot flue at a slant, without the normal work result of the hot flue that is otherwise expected being impaired.

Reference Symbol List:

1=textile web
2=transport direction (1)
3=tenter means
4=housing (5)
5=hot flue
6=inlet slit
7=deflection roller
8, 9=guide roller series
10, 11=guide rollers
12=deflection roller
13=outlet slit
14=tenter means
15, 16=blowing nozzles
17=slanted group of rollers
18=axis

1. Device for preparing textiles that precedes their garment-making, having means, among other things, for skewing a textile web (1), particularly one consisting of denim goods, and having at least one hot flue (5) and a series (8, 9) of guide rollers mounted essentially in one horizontal plane each, for the textile web, as well as having means (3, 14) that precede and follow (the hot flue), for exerting a lengthwise draw on the textile web (1), wherein at least one group (17) of at least one series of guide rollers is mounted tilted at a slant in one direction, in relation to the horizontal plane that passes through the series (9) of guide rollers.

2. Device as recited in claim 1, wherein the slanted guide rollers (17) are tilted about an axis (18) that lies parallel to the plane of a roller series (9) and/or parallel to the average transport direction (2), in the direction towards the other roller series (8), in each instance.

3. Method for operating the device as recited in claim 1, wherein the textile web (1) is both, i.e. simultaneously skewed in the hot flue (5) and dried in the circulating air.
